(19) United States
(12) Patent Application Publication
(10) Pub. No.: US 2007/0183311 A1
(43) Pub. Date: Aug. 9, 2007

(54) Flat-spectrum and spectrum-shaped waveforms for digital communications

(76) Inventor: Vlad Mitlin, San Diego, CA (US)

Correspondence Address: Vlad Mitlin, 15358 Calle Juanito, San Diego, CA, 92129, US

(21) Appl. No.: 11/346,056

(22) Filed: Feb. 3, 2006

(51) Int. Cl. H04J 11/00

(52) U.S. Cl. 370/210

(57) ABSTRACT

In accordance with the present invention, there is provided a method of generating, for a given natural q, a set of q complex sequences of a constant envelope DFT-transformed into sequences also of a constant envelope. It is shown that these sequences are transformed into themselves upon applying the DFT twice. A digital communications method with enhanced bandwidth and transmitted power utilization employing these sequences as basic transmission objects is described. Finally, a method of generating complex sequences identical to their discrete spectra is described.

### FIELD OF THE INVENTION

The present invention relates to designing new waveforms with special properties for digital communications and, more particularly, to developing complex waveforms of a constant envelope having spectra of a constant envelope and complex waveforms shaped like their spectra.

### BACKGROUND OF THE INVENTION

One of the biggest challenges of modern digital communications is designing signal waveforms with improved transmission properties. A properly chosen waveform can substantially enhance the bandwidth utilization, and/or reduce the needed transmission power, and/or improve the peak-to-average power ratio in a communications system.

Recently, we identified and described a new class of waveforms termed “flat spectrum chirps” (FSC) (Mitlin, 2004). They are represented by complex sequences of a constant envelope mapped by the discrete Fourier transform (DFT) onto complex sequences also of a constant envelope. It was mathematically proven in (Mitlin, 2004) that they are optimal phase shifters capable of greatly reducing peak-to-average power ratios in multicarrier communications systems.

Flat spectrum chirps are perfect spreading sequences evenly occupying the bandwidth slot where the transmission occurs so that for a given bandwidth the transmission power would be minimized by using FSC. Therefore, they appear to have much promise if served as basic transmission units in a digital communications system.

This patent application further develops the concept of FSC. It explores another amazing property which we have just discovered, e.g. an FSC transforms into itself upon applying the DFT twice. This property allows us, first, to widen the class of flat spectrum waveforms by including discrete spectra of the existing FSCs; and secondly, to introduce a method of generating waveforms that are identical to their discrete spectra. This application describes properties of these waveforms and discusses their possible applications for digital communications.

The present application is related to the U.S. patent application Ser. No. 10/945,974 titled: “Phase Shifters for Peak-To-Average Power Ratio Reduction in Multi-Carrier Communications Systems”, invented by Vlad Mitlin, filed on 19 Sep. 2004 and owned by the same assignee now and at the time of invention.

### SUMMARY OF THE INVENTION

In accordance with the present invention, there is provided a method of generating, for a given natural q, a set of q complex sequences of a constant envelope DFT-transformed into sequences also of a constant envelope. It is shown that these sequences are transformed into themselves upon applying the DFT twice. A digital communications method with enhanced bandwidth and transmitted power utilization employing these sequences as basic transmission objects is described. Finally, a method of generating of complex sequences identical to their discrete spectra is described.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a dependence R(D) where R is given by Eq. (16) and D is given by Eq. (17);

FIG. 2 shows the real part of an FSC at q=4 and p=1;

FIG. 3 shows the imaginary part of an FSC at q=4 and p=1;

FIG. 4 shows the real part of an FSC at q=4 and p=3;

FIG. 5 shows the imaginary part of an FSC at q=4 and p=3;

FIG. 6 shows the real part of a dual FSC at q=4 and p=1;

FIG. 7 shows the imaginary part of a dual FSC at q=4 and p=1;

FIG. 8 shows the real part of a dual FSC at q=4 and p=3;

FIG. 9 shows the imaginary part of a dual FSC at q=4 and p=3;

FIG. 10 is a dependency of the symbol error rate on the SNR in a FSC-based communications system for different sizes of alphabets;

FIG. 11 shows the absolute values of spectra of an FSC (crosses) and a non-AWGN channel interferer (solid line);

FIG. 12 presents the real part of a BSSW at q=64 and p=41;

FIG. 13 presents the imaginary part of a BSSW at q=64 and p=41;

FIG. 14 shows the real part of a DSSW;

FIG. 15 shows the real part of another DSSW;

FIG. 16 presents the distribution of variances of 10,000 randomly chosen normalized DSSW;

FIG. 17 presents the distribution of PAPR values of 10,000 randomly chosen normalized DSSW;

FIG. 18 shows the absolute value of a BSSW at q=256 and p=7 at the transmitting station;

FIG. 19 shows the absolute value of a BSSW at q=256 and p=7 at the receiving station; and

FIG. 20 shows the absolute value of a BSSW at q=256 and p=7 at the receiving station after performing 10 iterations of Eq. (25).

For purposes of clarity and brevity, like elements and components will bear the same designations and numbering throughout the FIGURES.

### DESCRIPTION OF THE PREFERRED EMBODIMENT

1. Flat Spectrum Chirps

In this subsection it will be proven that for a given q, there exists a set z of complex, unit-envelope sequences of the length q having a unit-envelope DFT, i.e.

$$\vert {z}^{->} \vert = 1 ; \vert DFT ( {z}^{->} ) \vert = 1$$

$$where$$

$$\{ DFT ( {z}^{->} ) \} = \{ \frac{1}{\sqrt{q}} {\sum }_{r = 0}^{q - 1} {z}_{r} exp ( - 2 jπ nr / q ) \}$$

This set is defined as follows:
\vec{z}(r)={exp(±jπr²p/q)} (1)

In Eq. (1) the integer r varies between 0 and q−1; integers p and q are mutually prime and have opposite parities; and j²=−1. Eq. (1) describes linear chirps that are well known in digital communications. However, a chirp with mutually prime p and q of opposite parities has a unit-envelope DFT as well. To show this let us consider the following sum:

$$S ( p , q ) = {\sum }_{r = 0}^{q - 1} exp ( - jπ {r}^{2} p / q ) \qquad ( 2 )$$

This is termed the Gauss sum and is considered in the number theory.

First, it will be proven that the absolute value of a Gauss sum, for p and q specified, is independent of p. Some known properties of Gauss sums will be used. The first property is its multiplicaticity:
(q′,q″)=1S(p,q′q″)=S(pq′,q″)S(pq″,q′) (3)
i.e. at mutually prime q′ and q″ the sum on the l.h.s. of Eq. (3) can be presented as a product of two other sums. Apply the property (3) to the Gauss sum as follows:
S(1,pq)=S(p,q)S(q,p) (4)

It did not seem to simplify the problem; however, there is another property of Gauss sums called the Schaar's identity, and it holds for mutually prime p and q of opposite parity. This identity can be presented as follows:
S*(p,q)=exp(jπ/4)\sqrt{q/p}S(q,p) (5)
where ‘*’ denotes a complex conjugate. Combining Eqs. (4) and (5) yields:
exp(jπ/4)\sqrt{q/p}S(1,pq)=|S(p,q)|² (6)

The sum on the l.h.s. of Eq. (6) can be evaluated by using again the Schaar's identity:
S(1,pq)=exp(−jπ/4)\sqrt{pq}S*(pq,1)=exp(−jπ/4)\sqrt{pq} (7)

Introducing Eq. (7) into Eq. (6) yields:
|S(p,q)|²=q (8)

This is what had to be proven.

Next, let us show that for p and q of opposite parity, shifting r in this Gauss sum by an integer m does not change it:

$${\sum }_{r = 0}^{q - 1} exp ( - jπ {r}^{2} p / q ) = {\sum }_{r = 0}^{q - 1} exp ( - {jπ ( r + m )}^{2} p / q ) \qquad ( 9 )$$

The property (9) can be easily proven by induction: we just have to show that (9) is true for a unit shift. This can be seen from the following equality:

$${\sum }_{r = 0}^{q - 1} exp ( - j π {r}^{2} p / q ) = {\sum }_{r = 0}^{q - 1} exp ( - {jπ ( q - 1 - r )}^{2} p / q ) \qquad ( 10 )$$

which, for p and q of opposite parity, can be rewritten as follows:

$${\sum }_{r = 0}^{q - 1} exp ( - jπ ( qp - 2 p ( 1 + r ) + {( 1 + r )}^{2} p / q ) ) = {\sum }_{r = 0}^{q - 1} exp ( - {jπ ( r + 1 )}^{2} p / q ) \qquad ( 11 )$$

Now, Eq. (9) is equivalent to the following equation:

$${\sum }_{r = 0}^{q - 1} exp ( - 2 j π nr / q - j π {r}^{2} p / q ) = S ( p , q ) exp ( jπ {m}^{2} p / q ) , \\ mp = n ( mod q ) \qquad ( 12 )$$

Eq. (12) establishes a relation between the DFT of a chirp with parameters p and q specified above and the Gauss sum in Eq. (1). Since p and q are mutually prime, it is always possible, for a given n, to find m such that remainders of dividing mp and n by q are equal. Moreover, for a given n, such m is uniquely found. Therefore, the DFT of such a chirp has a constant envelope of unity:

$$\vert DFT ( {z}^{->} ) \vert = \vert \frac{1}{\sqrt{q}} {\sum }_{r = 0}^{q - 1} exp ( - 2 jπ nr / q - jπ {r}^{2} p / q ) \vert = \frac{\vert S ( p , q ) \vert}{\sqrt{q}} = 1 \qquad ( 13 )$$

A chirp, whose constant envelope property pertains to the DFT, is termed the flat spectrum chirp (FSC). While the proof was presented for an FSC with a minus sign in Eq. (1), since absolute values of a complex number and its conjugate are equal, the constant envelope property holds for an FSC with a plus sign in Eq. (1) too. Also, as the IDFT matrix is a conjugate to the DFT matrix, the constant envelope property of an FSC pertains to IDFT too.

2. DFT(DFT(FSC))=FSC

In this subsection it will be proven that FSCs have another remarkable property, e.g. applying the DFT to an FSC twice yields the same FSC.

The proof is numerical. Specifically, a Matlab script was written that computes several functions of p and q. The first function is:
r(q,p)=1−sign((gcd(q,p)+(q%2)·(p%2)−1)²) (14)

In Eq. (14) gcd stands for the greatest common divisor of two natural numbers; and ‘%’ denotes the computing a remainder of dividing one integer by another. The function r equals 1 for mutually prime p and q of opposite parity, and equals 0 otherwise.

The second function is:
d(q,p)=1−sign(|\vec{z}(q,p)−DFT(DFT(\vec{z}(q,p)))|²) (15)

In Eq. (15) the vector z corresponds to a sequence defined by Eq. (1). The function d equals 1 if the double DFT of z coincides with z, and it equals 0 otherwise.

The third function is:

$$R ( M , Q ) = {\sum }_{q = M}^{Q} {\sum }_{p = 1}^{q} r ( q , p ) \qquad ( 16 )$$

The fourth function is:

$$D ( M , Q ) = {\sum }_{q = M}^{Q} {\sum }_{p = 1}^{q} d ( q , p ) \qquad ( 17 )$$

In Eqs. (16) and (17) M and Q are positive integers, and M<Q.

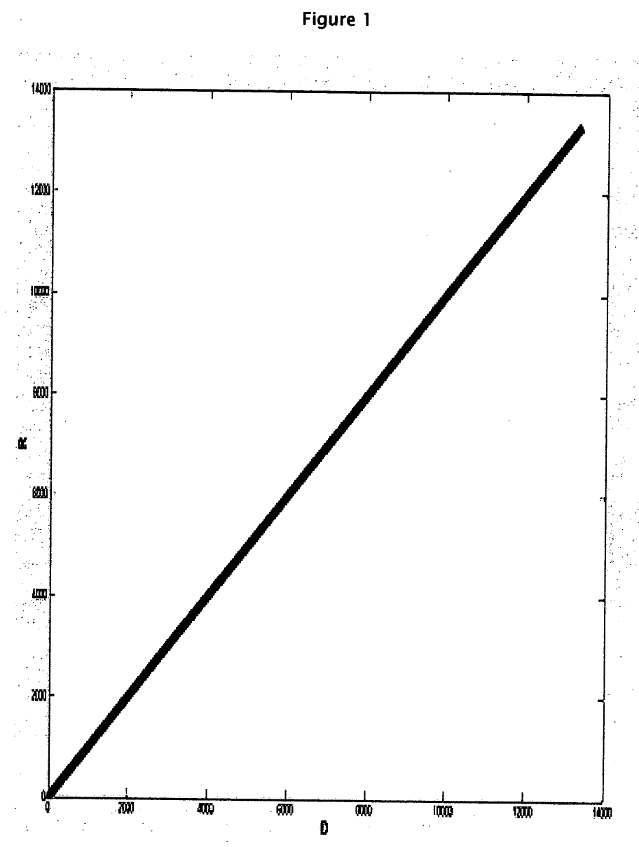

FIG. 1 shows the dependence R(D) at M=2 and Q running between 2 and 256 which is the range of most interest for waveform sizes. One can see that R=D for all Q from this interval which constitutes the numerical proof of the statement made in the beginning of this subsection.

One should note that FSC is not the only chirp transformed to itself upon applying the DFT twice. As an example, at q=6 all chirps given by Eq. (1) have this property, although not all of them correspond to mutually prime p and q of opposite parity. To determine whether a given chirp has this property, a direct computation similar to the one described in this subsection should be performed.

3. Dual FSC

It was proven in the first subsection that for an FSC, we have:
|\vec{z}|=1; |DFT(\vec{z})|=1 (18)

It was proven in the second subsection that for an FSC, we have:
DFT(DFT(\vec{z})=\vec{z} (19)

It follows from Eqs. (18) and (19) that if
\vec{Z}=DFT(\vec{z}) (20)
then
|\vec{Z}|=1; |(DFT(\vec{Z}))|=1; (21)
i.e. if z is an FSC then Z=DFT(z) has the same property that z has, e.g. it is a complex, unit-envelope sequence mapped by the DFT to another complex, unit-envelope sequence. Z is termed the “dual FSC” (DFSC).

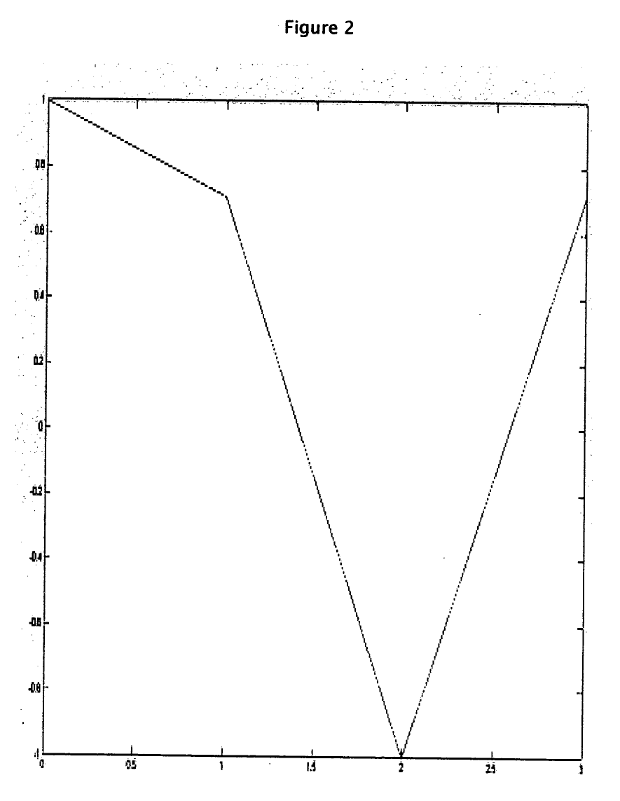

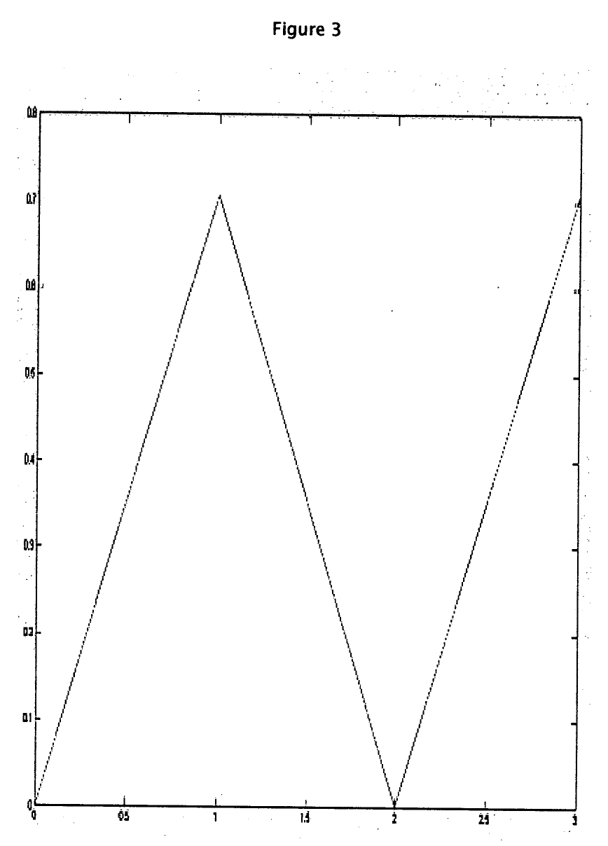

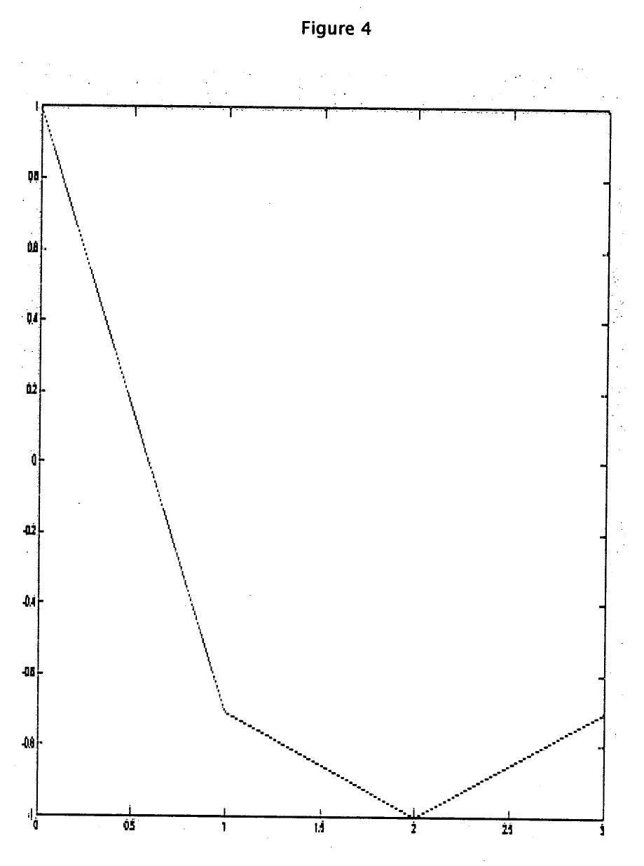

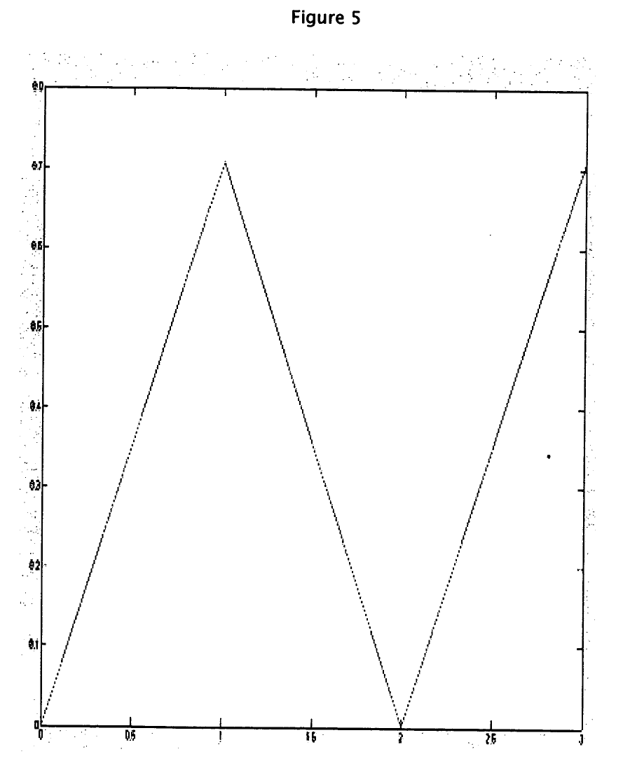

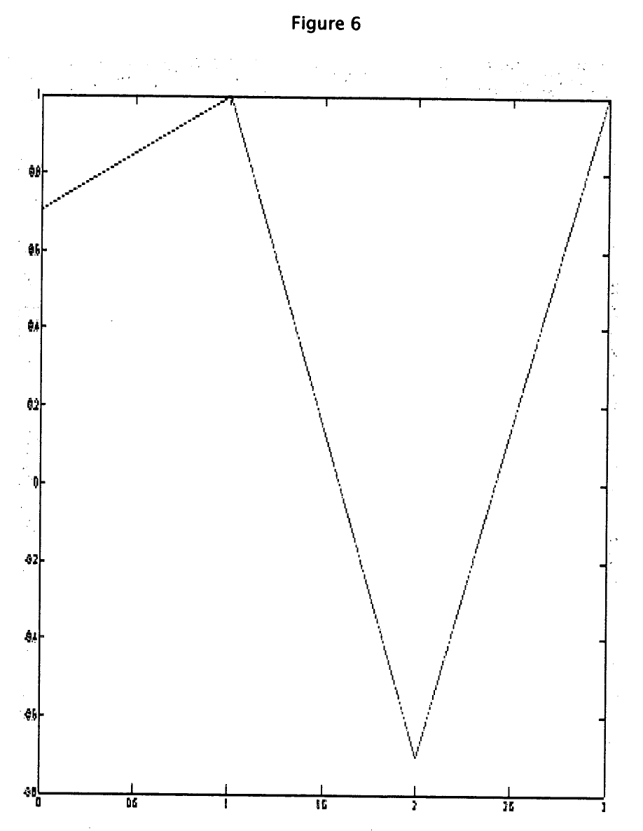

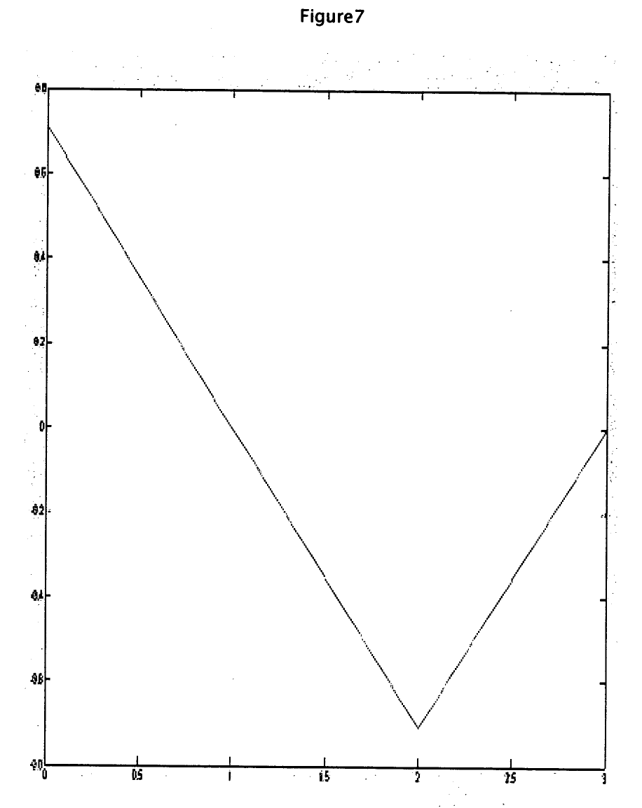

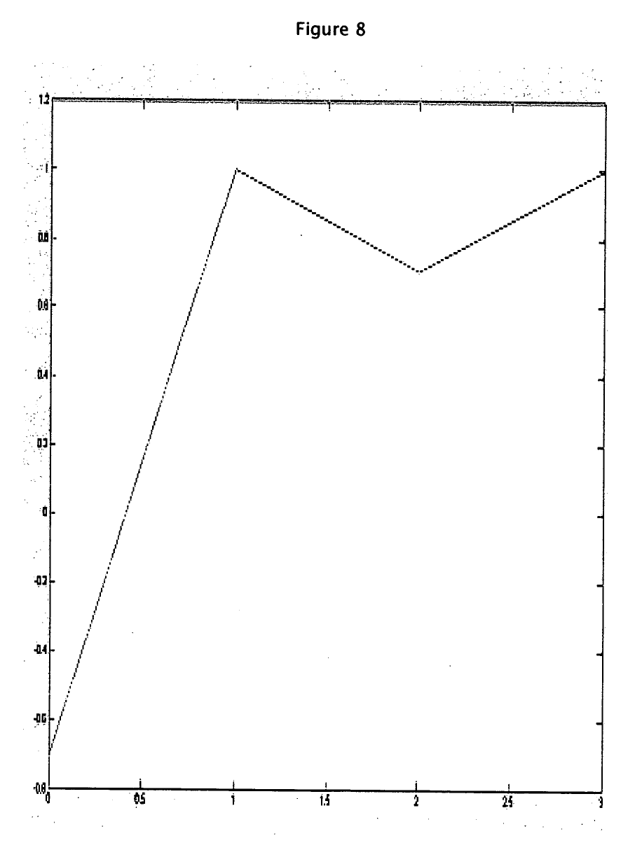

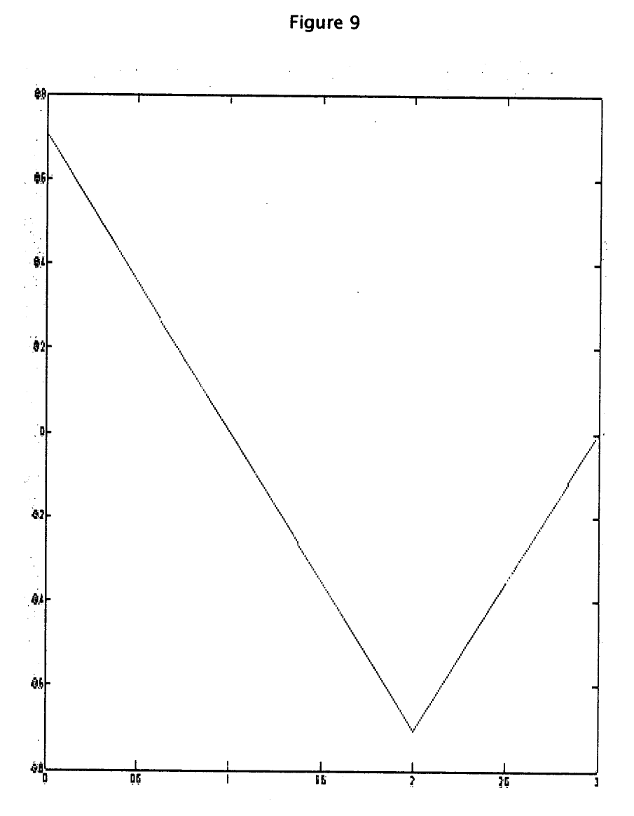

Real and imaginary parts of the complete set of FSC and DFSC at q=4 is shown in FIGS. 2 to 9.

In a special case of q being a power of 2 and p=1, the real and the imaginary part of the FSC and those of its spectrum are all the same.

As described in (Mitlin, 2004), complex sequences of constant envelope mapped by DFT to complex sequences of constant envelope are ideal for reducing peak-to-average power ratios of complex waveforms obtained as the q-point IDFT of complex messages of the length q (for example, in orthogonal frequency division multiplexing (OFDM) communications systems). This can be done by multiplying the r-th component of each of these messages by the r-th component of an FSC/DFSC where r is an integer such that 0≦r<q at the transmitter. To retrieve an original message at the receiver the r-th component of the output of the DFT module of the receiver is divided by the r-th component of this FSC/DFSC.

Furthermore, using a plurality of FSCs/DFSCs can provide a powerful communications security mechanism in the physical layer if messages are consecutively retrieved from a data stream; for each message retrieved, and parameters of the corresponding FSC/DFSC are determined based on the value of a current element of a pseudorandom sequence that is held proprietary by the owner of the data stream.

4. FSC/DFSC-Based Transmission Method

If q is a power of 2 there is a set of q/2 FSC corresponding to odd p<q and a set of q/2 DFSC; thus, there are q complex, unit-envelope baseband waveforms having unit-envelope spectra, i.e. uniform spectral densities. This means that for a given bandwidth, these waveforms have minimal possible power (the envelope squared); i.e. they are perfect spreading sequences. They appear to be perfectly suitable to serve as basic transmission units for power and bandwidth efficient data transmission.

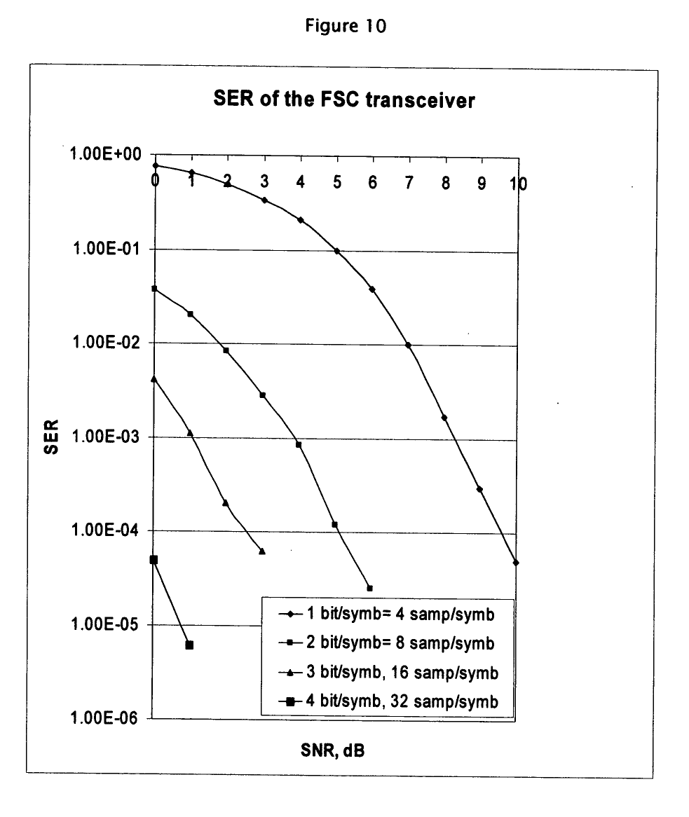

We developed a simulator to prove this concept. We simulated the data transmission over an AWGN baseband channel. Four cases were considered, and in each case 100,000 FSC of the length q=4, 8, 16, and 32 samples, respectively, were transmitted. Accordingly, sets of two, four, eight, and sixteen FSC waveforms were used. FSC sets were mapped to alphabets consisting of two, four, eight, and sixteen symbols, respectively, corresponding to transmission of one, two, three, and four bits per symbol. The detection of a waveform was made by computing Euclidian distances between the received signal and each of FSC from the set used and selecting the symbol corresponding to FSC with the minimum distance. FIG. 10 shows the symbol error rate versus the SNR for the different sizes of alphabets. Simulation results for a DFSC-based system are similar to those shown in this figure and are not presented here.

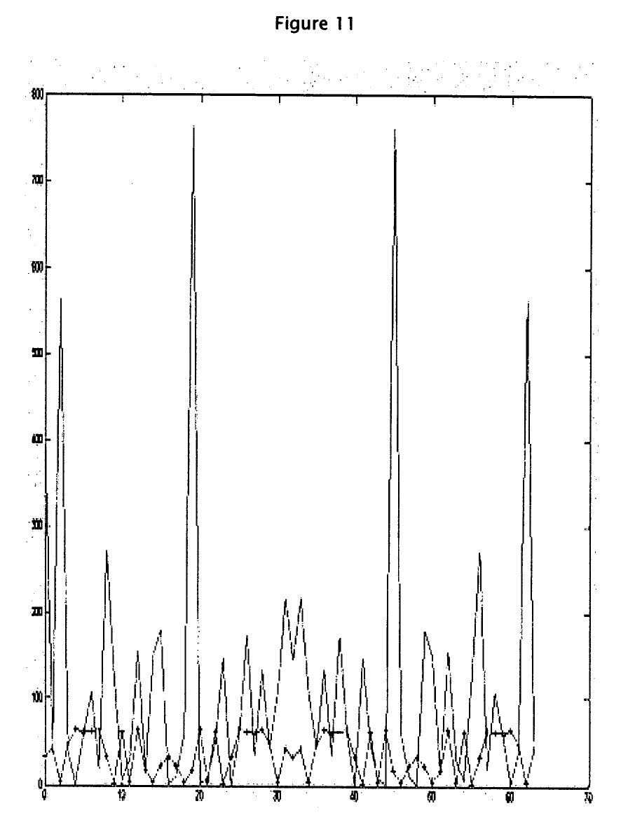

FIG. 11 shows some of the results of another simulation set in which the channel was distorted by a non-AWGN interferer. Its spectrum is shown in FIG. 11 by a solid line. Data transmission was performed using a set of 32 FSC with q=64. The spectrum of a typical FSC from this set is shown in FIG. 11 by crosses. 32000 symbols were transmitted at the signal-to-interferer ratio of about −5 dB, and no errors were detected. One can see that the new waveforms have excellent transmission qualities.

An additional improvement in the detection was attained when the waveform received, z, was pre-processed at the receiver as follows:

$${z}^{->} -> \frac{DFT ( DFT ( {z}^{->} ) ) + {z}^{->}}{2} \qquad ( 22 )$$

prior to computing the Euclidean distances.
5. Basic Spectrum-Shaped Waveforms

Let us consider another remarkable feature of the FSC/DFSC waveforms. As both an FSC and its corresponding DFSC satisfy Eq. (19), one can write:
DFT(\vec{z}+DFT(\vec{z}))=DFT(\vec{z})+DFT(DFT(\vec{z}))=DFT(\vec{z})+\vec{z} (23)
In other words, the sum of an FSC and its corresponding DFSC transforms by the DFT into itself. We termed this sum the “basic spectrum-shaped waveform” (BSSW).

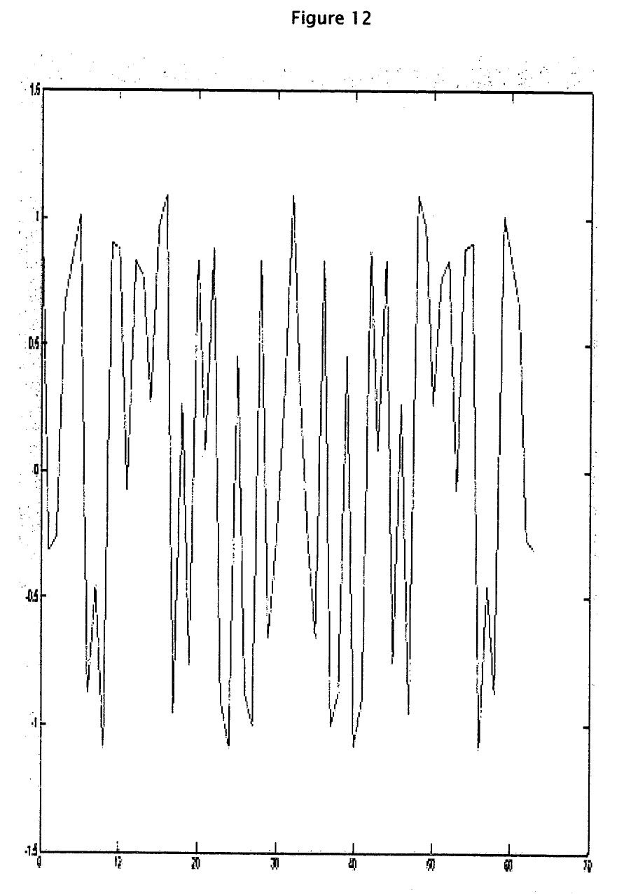

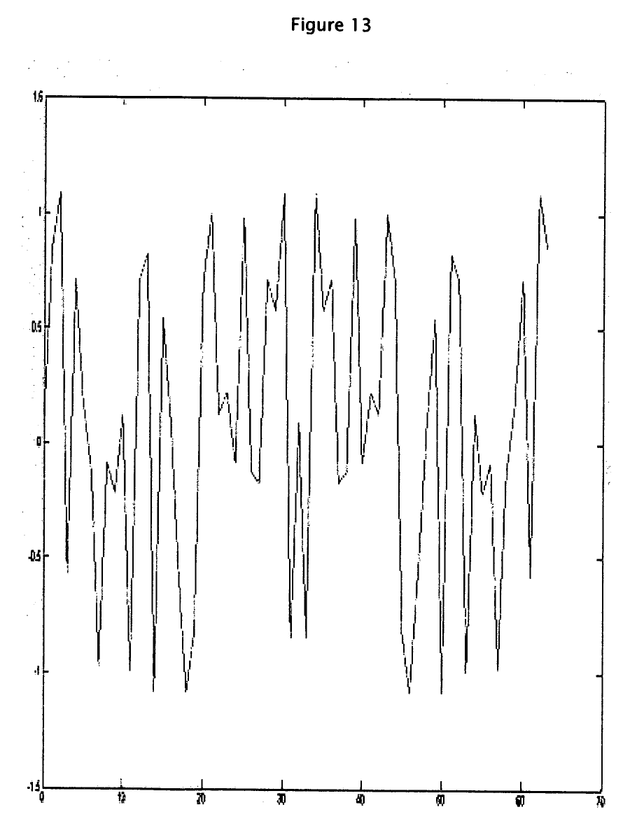

As an example, for q equal to the power of two, there are q/2 different BSSW. The real and imaginary parts of a BSSW at q=64 and p=41 are shown in FIGS. 12 and 13.

6. Derivative Spectrum-Shaped Waveforms

Here we show that for a given q, one can construct an infinite number of spectrum-shaped waveforms. Specifically, as the DFT is a linear operation, any linear combination of several BSSW will be a spectrum-shaped waveform. We termed them “derivative spectrum-shaped waveforms” (DSSW). These waveforms are defined as follows:
DSSW=ΣaₖBSSWₖ (24)

In Eq. (24) aₖ are arbitrary complex numbers.

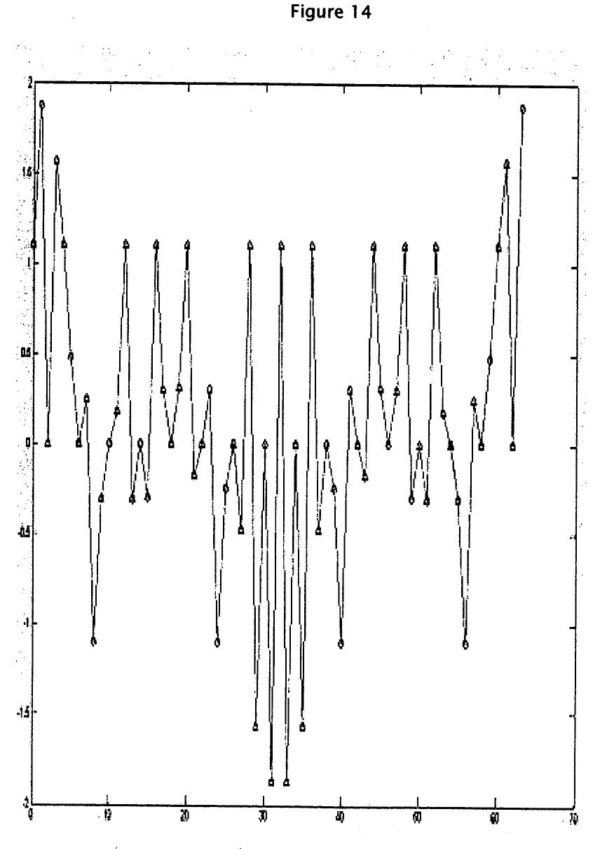

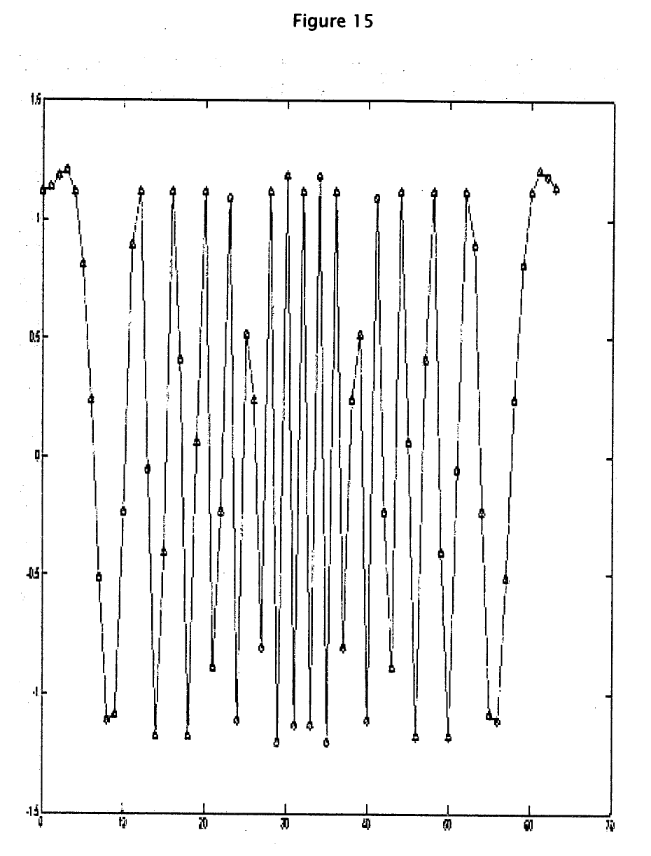

For a given q, there is an innumerous number of different derivative spectrum-shaped waveforms. An example of the real part of the DSSW obtained as a sum of an FSC with q=64 and p=1 and another FSC with q=64 and p=13 is presented in FIG. 14. Another example of the real part of a limiting case of DSSW, e.g. an FSC with q=64 and p=1 is shown in FIG. 15.

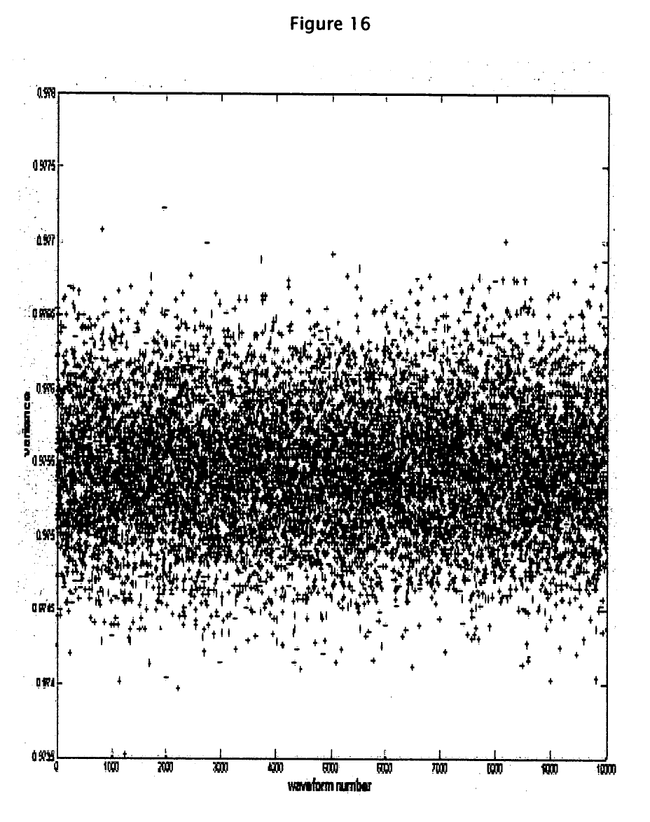

Statistical properties of DSSW, however, are very similar, for the same q. FIG. 16 shows the values of variances of 10000 DSSW at q=64, normalized to unit power and generated by randomly choosing the weights aₖ such that

$${\sum }_{k = 1}^{q / 2} {a}_{k} = 1$$

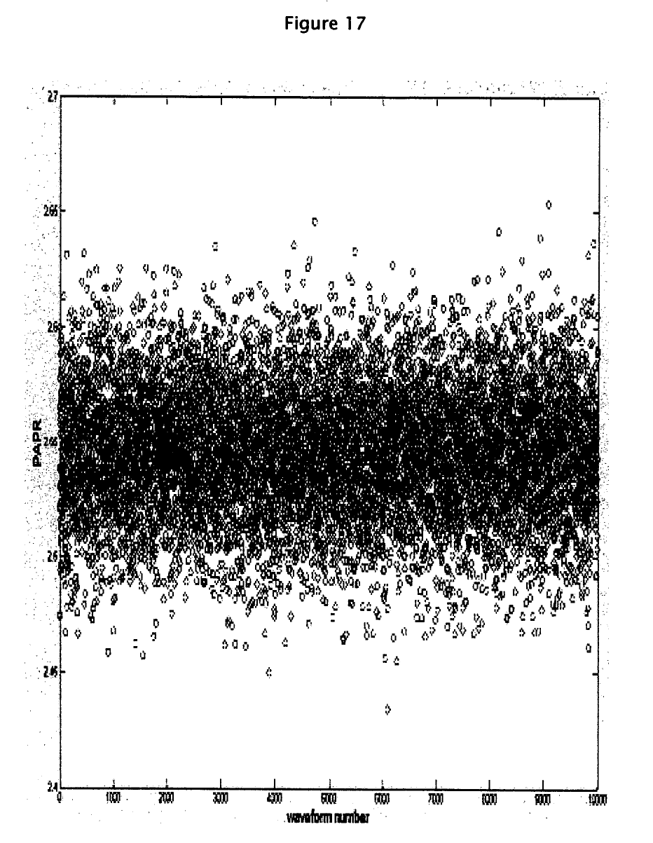

FIG. 17 shows the values of PAPR in this simulation. One can see that variation of each of these parameters over the variety of DSSW is within ten percent.

One can envision various applications of DSSW; below we will describe just one of them. DSSW can be generated in a large network as individual communication tools for each user. Specifically, DSSW can be generated and distributed among the users to be their authentication waveforms. At the beginning of a communication session between any two users they have to exchange their authentication waveforms to identify themselves. DSSW are suited very well for this purpose because they coincide with their spectra. This allows an enhanced reconstruction of the authentication waveform received, as follows. Upon receiving the waveform s from a peer, a user performs the following transformation:

$$\vec{s} = \frac{\vec{s} + DFT ( \vec{s} )}{2} \qquad ( 25 )$$

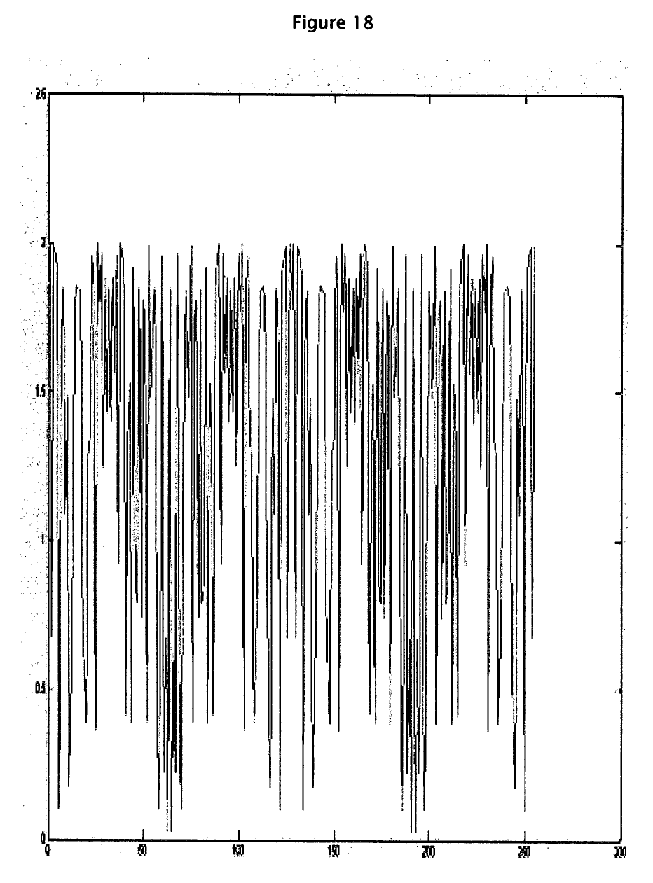

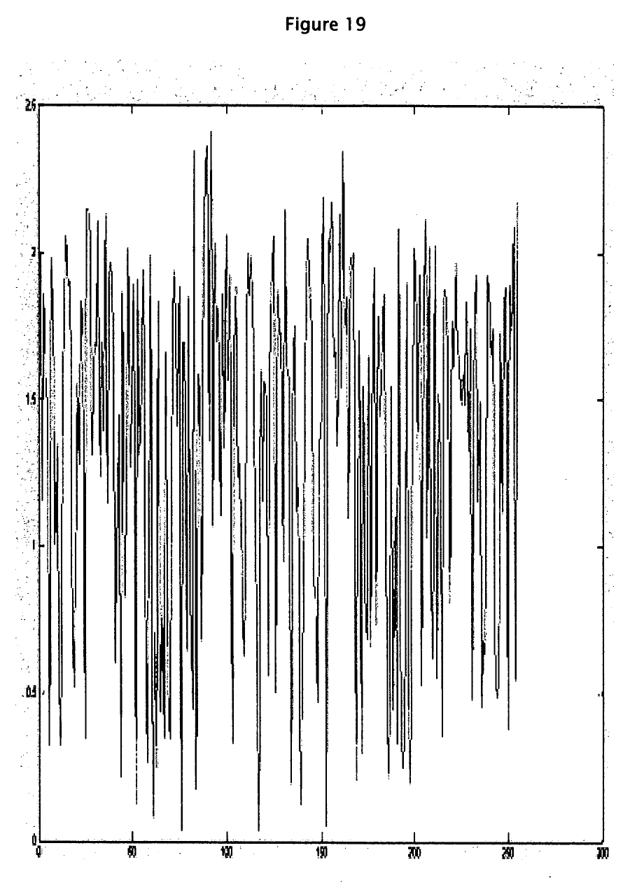

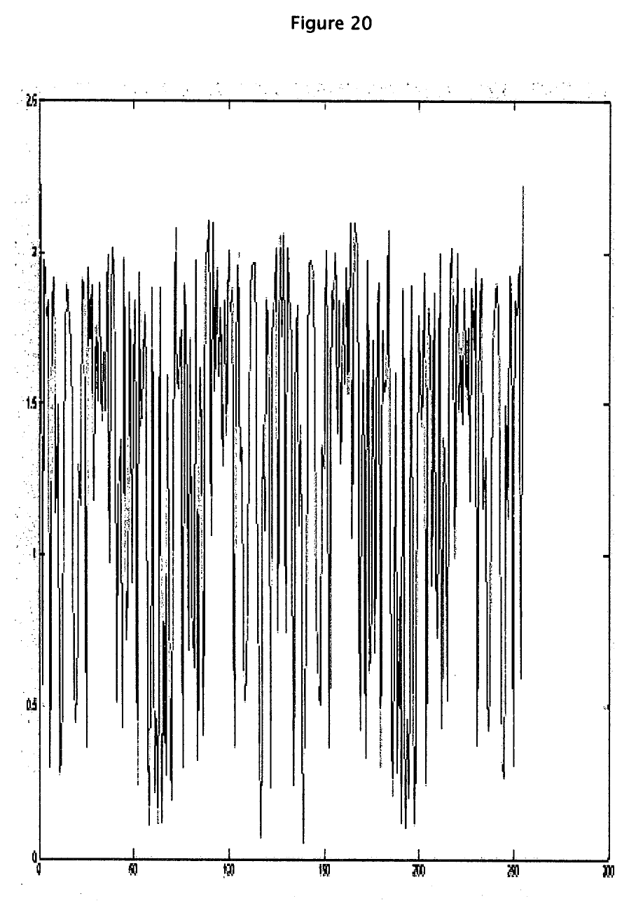

at least once. FIG. 18 shows absolute values of a BSSW at q=256 and p=7. An authentication event was simulated in the AWGN channel with the SNR of 10 dB. FIG. 19 shows absolute values of the BSSW at the receiver without performing preprocessing using Eq. (25). FIG. 20 shows absolute values of the BSSW at the receiver after performing 10 iterations of Eq. (25). One can see that using preprocessing routine (25) greatly improves the convergence of the authentication waveform received to the one transmitted. Our numerical experiments show that the convergence does not improve much after about 10 iterations.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of reducing the peak-to-average power ratio of a complex waveform obtained as the q-point inverse discrete Fourier transform of a complex message of the length q comprising:
generating a complex, constant envelope sequence of the length q such that its q-point discrete Fourier transform is of a constant envelope; and
multiplying the r-th component of the message by the r-th component of the sequence, for integer r such that 0≦r<q.

2. The method of claim 1 further comprising restoring said message from said waveform by means of dividing the r-th component of the q-point discrete Fourier transform of the waveform by the r-th component of said sequence, for integer r such that 0≦r<q.

3. The method of claim 1 wherein a plurality of said messages is consecutively retrieved from a data stream; for each message retrieved, parameters of said sequence are determined based on the value of a current element of a pseudorandom sequence that is held proprietary by the owner of the data stream.

4. The method of claim 2 wherein said sequence is a flat spectrum chirp of the length q generated by choosing a number p such that p and q are mutually prime integers having opposite parities; and computing components a(r) of the flat spectrum chirp according to the formula a(r)=exp(j*π*m*p*r²/q) where j²=−1, r is an integer such that 0≦r<q; and m equals either 1 or −1 for all r.

5. The method of claim 2 wherein said sequence is a dual flat spectrum chirp of the length q generated by choosing a number p such that p and q are mutually prime integers having opposite parities; computing components a(r) of a flat spectrum chirp according to the formula a(r)=exp (j*π*m*p*r²/q) where j²=−1, r is an integer such that 0≦r<q; and m equals either 1 or −1 for all r; and computing the q-point discrete Fourier transform of said flat spectrum chirp.

6. A method of data transmission comprising:
generating n≧2 different complex, constant envelope sequences of the length q such that their q-point discrete Fourier transforms are of a constant envelope; said sequences are mapped to an alphabet consisting of n different symbols; there is a data stream of said symbols at a transmitting station; a current symbol from said data stream is mapped to one of the sequences; said sequence is converted to an analog signal; said signal is transmitted over the communication channel and received, digitized, and identified at the receiving station.

7. The method of claim 6 wherein k said sequences, 0≦k≦n, are flat spectrum chirps of the length q generated by choosing a number p such that p and q are mutually prime integers having opposite parities; and computing components a(r) of the flat spectrum chirp according to the formula a(r)=exp(j*π*m*p*r²/q) where j²=−1, r is an integer such that 0≦r<q; and m equals either 1 or −1 for all r.

8. The method of claim 7 wherein n-k said sequences, 0≦k≦n, are dual flat spectrum chirps of the length q generated by choosing a number p such that p and q are mutually prime integers having opposite parities; computing components a(r) of a flat spectrum chirp according to the formula a(r)=exp(j*π*m*p*r²/q) where j²=−1, r is an integer such that 0≦r<q; and m equals either 1 or −1 for all r; and computing the q-point discrete Fourier transform of said flat spectrum chirp.

9. An authentication method for communications between a transmitting station and a receiving station comprising:
at the transmitting station an authentication waveform is generated and transmitted;
the authentication waveform is identical to its discrete Fourier spectrum;
at the receiving station the waveform is received and identified;
the identification is performed by computing the mean of the waveform and its discrete Fourier transform at least once and comparing the result to all valid authentication waveforms stored at the receiving station;
in the case of a positive identification communications continue;
in the case of a negative identification communications end;

10. The method of claim 9 wherein said authentication waveform is a basic spectrum-shaped waveform, a complex sequence of the length q such that it is mapped by the q-point discrete Fourier transform to itself, generated by choosing a number p such that p and q are mutually prime integers having opposite parities; computing components a(r) of a flat spectrum chirp according to the formula a(r)=exp(j*π*m*p*r²/q) where j²=−1, r is an integer such that 0≦r<q; and m equals either 1 or −1 for all r; computing components of a dual flat spectrum chirp by taking the q-point discrete Fourier transform of the flat spectrum chirp; and adding the r-th component of the flat spectrum chirp with parameters p and q and the r-th component of the dual flat spectrum chirp with parameters p and q, for integer r such that 0≦r<q.

11. The method of claim 10 wherein the authentication waveform is a derivative spectrum-shaped waveform, a complex sequence of the length q such that it is mapped by the q-point discrete Fourier transform to itself, obtained as a linear combination of several said basic spectrum-shaped waveforms with predefined weights.
